(19) United States
(12) Patent Application Publication
(10) Pub. No.: US 2007/0089754 A1
(43) Pub. Date: Apr. 26, 2007

(54) Protective sleeve for an oral airway and method

(76) Inventor: Perrin W. Jones, Greenville, NC (US)

Correspondence Address: Walter L. Beavers, 326 South Eugene Street, Greensboro, NC, 27401, US

(21) Appl. No.: 11/248,841

(22) Filed: Oct. 12, 2005

(51) Int. Cl. A61C 5/14

(52) U.S. Cl. 128/861

(57) ABSTRACT

A resilient, tubular sleeve is provided for use in combination with an oral airway during conventional medical intubation procedures. The sleeve is formed from a resilient material designed to stretch while placing it on the airway and to tightly engage the airway once in place. The sleeve is formed of a resilient material whereby the patient's teeth are protected from chipping and cracking should the patient bite the airway or grind his teeth during the procedure.

### FIELD OF THE INVENTION

The invention herein pertains to airway maintenance devices and particularly pertains to a combination protective sleeve and conventional oral airway for use during certain medical procedures.

### DESCRIPTION OF THE PRIOR ART AND OBJECTIVES OF THE INVENTION

Oral or oropharyngeal airways have been used for many years to help anesthesiologists and medical personnel in the maintenance of a patient's upper airway. Oropharyngeal airways generally provide a curved conduit that passes over the teeth and tongue, thereby preventing upper airway occlusion by the tongue resting on the soft pallet. For a patient under general anaesthesia or sedation, the oral airway also prevents the patient from biting down on the endotracheal tube causing acute airway obstruction. Guedel and Berman airways are common and include a curved section joined to a straight section terminating with a mouthpiece flange. With the airway in place certain surgical procedures can be accomplished but oftentimes the patient bites or grinds his teeth on the straight portion of the airway. Grinding or biting can result in the teeth being chipped or broken, usually with only minimal damage to the airway. While the intended medical procedure is generally successful, in the aftermath a patient may discover fractured or chipped teeth which requires extraction, repair or other dental treatment. Thus based on the problems and disadvantages using Guedel, Berman and other standard oral airways, the present invention was conceived and one of its objectives is to provide a simple, yet effective means for preventing damage to a patient's teeth during a medical or surgical procedure.

It is still another objective of the present invention to provide a resilient sleeve which can be easily placed on a standard oral airway without undue effort or training.

It is yet another objective of the present invention to provide a resilient polymeric protective sleeve for use on a standard airway, the sleeve being disposable, and relatively inexpensive to manufacture and purchase.

Various other objectives and advantages of the present invention will become apparent to those skilled in the art as a more detailed description is set forth below.

### SUMMARY OF THE INVENTION

The aforesaid and other objectives are realized by providing a resilient sleeve for use in combination with a standard oral airway. A conventional airway such as the “Guedel” airway includes a curved distal section joined to a short, straight section with a proximal mouthpiece flange attached thereto. The resilient sleeve can thus be placed over the curved distal section and urged along the curved section onto the straight section, thus residing against the mouthpiece flange. The sleeve is stretchable so as to transgress the turns and angles to reach the straight section of the airway. The sleeve is formed from a resilient polymeric material such as by stamping from a closed-cell foam in bun form, such as Type LS200 minicel polyolefin foam as manufactured by Voltek, LLC of Lawrence, Massachusetts. The sleeve can be made with various outer shapes such as rectangular or cylindrical. A central channel is formed within the sleeve sized to accommodate the width and height of the airway sections. The airway and sleeve in turn accommodate usual oral airway. The combination sleeve and airway are then placed as usual in the mouth and throat of the patient for maintenance of a patient's upper airway and for protecting the patient's teeth.

### BRIEF DESCRIPTION OF THE DRAWINGS

FIG. 1 illustrates the protective sleeve of the invention prior to placement on the conventional oral airway;

FIG. 2 demonstrates the sleeve partially in place on the airway as shown in FIG. 1;

FIG. 3 shows the sleeve fully in place on the airway;

FIG. 4 depicts a top view of the combination sleeve and airway as shown in FIG. 3;

FIG. 5 pictures a rear perspective view of the sleeve as shown in FIGS. 1-4;

FIG. 6 features an alternate sleeve having a cylindrical configuration;

FIG. 7 illustrates a bottom view of the cylindrical sleeve as shown in FIG. 6, the rear and front faces being planar and identical; and

FIG. 8 demonstrates the combination sleeve and airway as shown in FIG. 3 as placed in the mouth and throat of a patient during a medical procedure.

### DETAILED DESCRIPTION OF THE PREFERRED EMBODIMENT AND OPERATION OF THE INVENTION

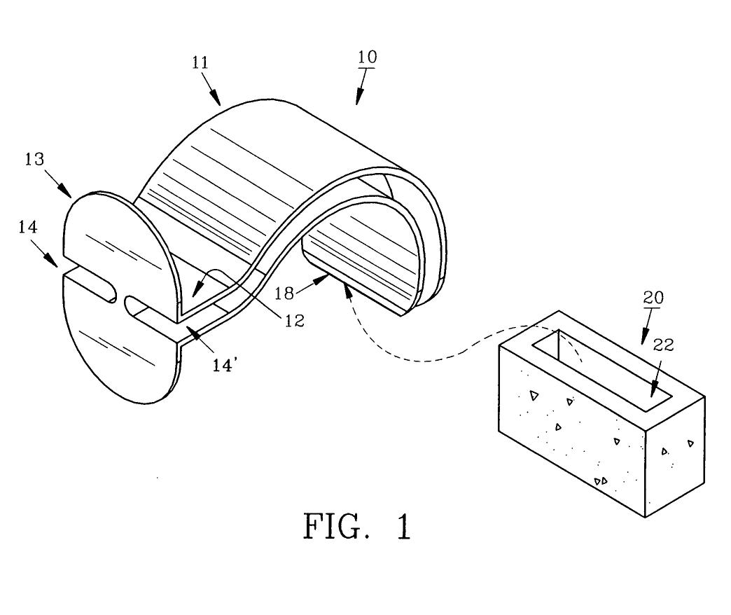

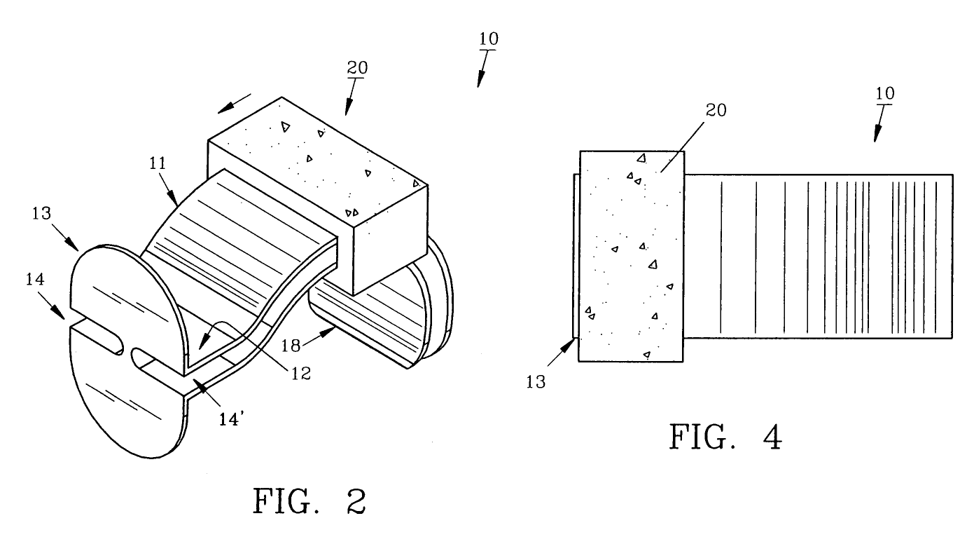

For a better understanding of the invention and its method of operation, turning now to the drawings, FIG. 1 shows a typical oral airway for use in maintenance of a patient's upper airway during a surgical or other medical procedure. Such devices are conventionally sold under the names of Guedel, Berman and others. As seen, airway 10 includes curved section 11, a generally straight section 12 and proximal mouthpiece flange 13. Channels 14, 14′ allow air passage during medical procedures. Preferred airway sleeve 20 is shown in FIG. 1 prior to positioning on airway 10. In FIG. 2 airway sleeve 20 has been urged past distal end 18 of airway 10 such as by manual manipulation. The preferred foam used for airway sleeve 20 is Type LS200 Minicel foam as manufactured by Voltek, LLC (Division of Sekisui America Corporation) of Lawrence, Massachusetts. The LS200 foam has the following properties:

| | |
|---|---|
| Density, pcf* | 2 |
| lbs/ft³ (pcf) | |
| Compression Strength* | |
| psi @ 25% | 4.1 |
| psi @ 50% | 10.9 |
| Tensile Strength* | 45 |
| psi | |
| Elongation to Break* | 273 |
| % | |
| Tear Resistance* | 7 |
| lbs/inch | |
| Compression Set* | 15.0 |
| % of original thickness | |
| Thermal Stability** | −4.1 |
| Three hours@ 158° F. | |
| % lineal shrinkage | |
| Recommended Temperature Range** | −110 to +160 |
| Degrees F. | |

*ASTM D3575
**Voltek Test Method

Sleeve 20 is a resilient, durable polymeric material preferably, a conventional closed-cell chemically crosslinked polyolefin elastomeric foam such as by stamping from a usual bun. While various types of closed-cell polymeric substances can be used, the substance must be resilient to allow compression on the teeth without failure to protect the teeth from striking rigid airway 10. Compressible closed-cell olefin foams are preferred such as manufactured by Voltek, LLC although other substances can be used as long as they provide stretch for mounting airway 10, resiliency and durability for protection of the teeth and airway.

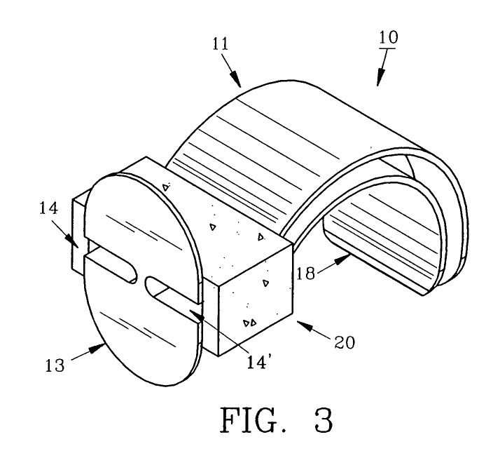

In FIG. 3 sleeve 20 has been pushed onto straight section 12 of airway 10 where it contacts the rear surface of proximal flange 13. A top view of the combination airway 10 and sleeve 20 is shown in FIG. 4. As would be understood, airway 10 with sleeve 20 affixed as in FIG. 4 is ready for placement into the mouth of a patient as shown in FIG. 8.

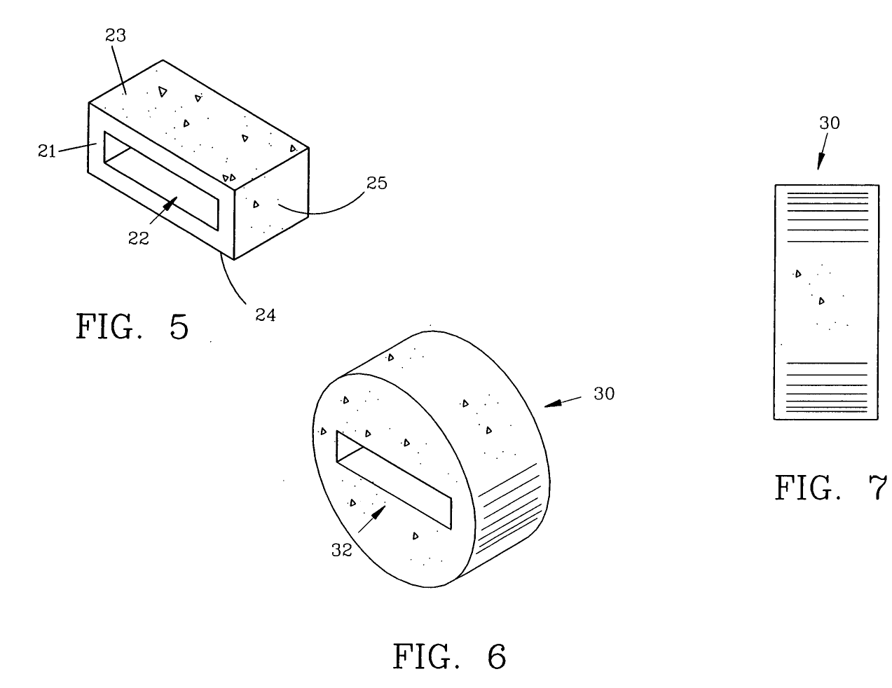

Sleeve 20 is shown in FIG. 5 in a rear view, it being understood that top 23 and bottom 24 have identical dimensions as do left side 21 and right side 25 with a length (front to back) of approximately 3 cm and a height (top to bottom) of about 2 cm. Channel 22 as shown in FIGS. 1 and 5 is sized to engage straight section 12 of adult airway 10 and channel 22 may have a height of approximately 1 cm and a width of approximately 2 cm.

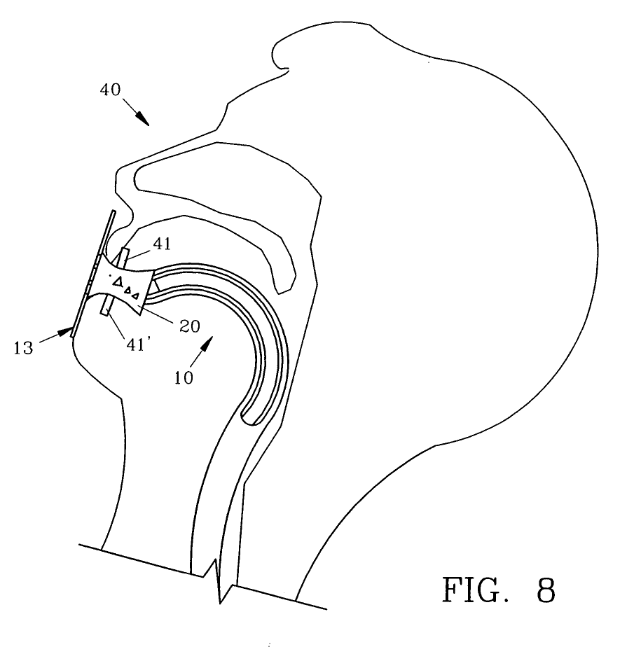

An alternate embodiment of sleeve 20 is shown in FIG. 6 shown by cylindrical shaped sleeve 30. Sleeve 30 functions in the same way as sleeve 20 and includes central passageway 32 having the same relative dimensions as passageway 22 of sleeve 20. A bottom view of sleeve 30 is shown in FIG. 7 with a planar front and rear.

The preferred method of use comprises selecting a specific oral airway such as oral airway 10 shown in FIG. 1 and placing a corresponding sleeve 20 thereon as shown in FIGS. 2 and 3. Once sleeve 20 has been so fully disposed, the combination airway 10 and sleeve 20 is then placed in the mouth and throat of the patient such as patient 40 shown in FIG. 8.

When the medical procedure is conducted, patient 40 can then bite sleeve 20 as frequently occurs without chipping or breaking teeth 41, 41′ seen schematically in FIG. 8.

The illustrations and examples provided herein are for explanatory purposes and are not intended to limit the scope of the appended claims.

I claim:

1. A device for placement on an oral airway comprising: a sleeve, said sleeve formed of a resilient material sized to fit the proximal end of the oral airway for preventing damage to the user's teeth.

2. The device of claim 1 formed from a polymeric material.

3. The device of claim 1 wherein said sleeve has a rectangular cross-section.

4. The device of claim 1 wherein said sleeve is expandable to pass over the proximal end of the oral airway when being placed thereon and contractible to securely engage the oral airway during use.

5. The device of claim 1 wherein said resilient material is a polymeric substance.

6. In combination, an oral airway and protective sleeve,
said oral airway comprising a proximal end and a distal end,
said protective sleeve formed from a resilient material, said protective sleeve positioned on said oral airway at said proximal end thereof.

7. The combination of claim 6 wherein said protective sleeve is formed from a polymeric substance.

8. The combination of claim 6 wherein said protective sleeve is expandable for convenient placement on said oral airway.

9. The combination of claim 6 wherein said protective sleeve has a rectangular cross-section.

10. A method of protecting the teeth of a patient using an oral airway, the method comprising the steps of:
a) selecting an oral airway for the patient;
b) selecting a resilient protective sleeve; and
c) placing the selected protective sleeve on the selected oral airway.

11. The method of claim 10 wherein placing the protective sleeve comprises the step of expanding the protective sleeve while placing it on the oral airway.

12. The method of claim 10 further comprising the step of inserting the oral airway into the patient's mouth.

13. The method of claim 12 wherein inserting the oral airway comprises the step of placing the oral airway with the protective sleeve between the patient's upper and lower teeth.

14. The method of claim 10 further comprising the step of removing the oral airway from the patient's mouth.

15. The method of claim 14 further comprising the step of removing the protective sleeve from the oral airway.
